(19) United States
(12) Patent Application Publication
(10) Pub. No.: US 2025/0282221 A1
(43) Pub. Date: Sep. 11, 2025

(54) VEHICLE DISPLAY CONTROL DEVICE AND VEHICLE DISPLAY CONTROL METHOD

(71) Applicant: TOYOTA JIDOSHA KABUSHIKI KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/018,442

(22) Filed: Jan. 13, 2025

(30) Foreign Application Priority Data
Mar. 7, 2024 (JP) 2024-035179

(51) Int. Cl. B60K 35/28; B60K 35/233; G06T 3/40; G06T 11/00

(52) U.S. Cl. CPC B60K 35/28; B60K 35/233; G06T 3/40; G06T 11/00; B60K 2360/182; G06T 2210/62

(57) ABSTRACT

A vehicle display control device, that acquires a peripheral situation of a host vehicle via a sensor; and, at a time of displaying an image showing the peripheral situation of the host vehicle at a display provided at a periphery of a driver's seat of the host vehicle, in a case in which an attribute of an object positioned at a periphery of the host vehicle is unclear, displays the object in a manner expressing that the attribute has not been confirmed, up until the attribute is confirmed.

### CROSS-REFERENCE TO RELATED APPLICATION

This application is based on and claims priority under 35 USC 119 from Japanese Patent Application No. 2024-035179 filed on Mar. 7, 2024, the disclosure of which is incorporated by reference herein.

### BACKGROUND

### Technical Field

The present disclosure relates to a vehicle display control device and a vehicle display control method.

### Related Art

Japanese Patent No. 6825709 discloses acquiring information of a periphery of a host vehicle, and by using the acquired information of the periphery of the host vehicle, generating a virtual image showing the periphery of the host vehicle as if the host vehicle was viewed from above. Before an automatic lane change is effected, when consideration as to whether or not to effect the automatic lane change starts, the display region of the periphery of the host vehicle in the virtual image is broadened as compared with before the start of consideration.

In accordance with the technique disclosed in Japanese Patent No. 6825709, a virtual image showing the periphery of the host vehicle is generated, and the generated virtual image can be displayed in a display region provided at the periphery of the driver's seat. On the other hand, there are cases in which, in the display region in which the virtual image is displayed, among the objects at the periphery of the host vehicle, all of the objects whose attributes are unclear are displayed as “sedans”. Therefore, there is the concern that the passenger will misunderstand the attributes of the objects.

### SUMMARY

An aspect of the present disclosure is a vehicle display control device that includes: a memory; and a processor coupled with the memory, the processor being configured to: acquire a peripheral situation of a host vehicle via a sensor; and at a time of displaying an image showing the peripheral situation of the host vehicle at a display provided at a periphery of a driver's seat of the host vehicle, in a case in which an attribute of an object positioned at a periphery of the host vehicle is unclear, display the object in a manner expressing that the attribute has not been confirmed, up until the attribute is confirmed.

### BRIEF DESCRIPTION OF THE DRAWINGS

FIG. 1 is a schematic drawing illustrating a portion of the vehicle cabin interior of a vehicle that includes a vehicle display control device relating to an embodiment;

FIG. 2 is a drawing illustrating an example of a display region of a first display portion relating to the embodiment;

FIG. 3 is a block drawing illustrating an example of hardware structures of the vehicle display control device relating to the embodiment;

FIG. 4 is a block drawing illustrating an example of functional structures of the vehicle display control device relating to the embodiment;

FIG. 5 is a drawing illustrating an example of a first virtual viewpoint through a third virtual viewpoint relating to the embodiment;

FIG. 6 is a drawing illustrating an example of an image showing a peripheral situation of a vehicle, which image is displayed in a region;

FIG. 7A is a drawing illustrating an example of an image showing the attribute of an object;

FIG. 7B is a drawing illustrating an example of an image showing the attribute of an object;

FIG. 7C is a drawing illustrating an example of an image showing the attribute of an object;

FIG. 7D is a drawing illustrating an example of an image showing the attribute of an object;

FIG. 8 is a drawing illustrating an example of an image that includes specific images;

FIG. 9 is a drawing illustrating a situation in which the specific images displayed in the region transition to sedan images;

FIG. 10 is a drawing illustrating a situation in which the specific images displayed in the region are deleted;

FIG. 11 is a drawing illustrating a situation in which the transparencies of the specific images displayed in the region change;

FIG. 12 is a drawing illustrating a state in which the sizes of the specific images displayed in the region are varied;

FIG. 13 is a drawing illustrating an example of a specific image database; and

FIG. 14 is a flowchart illustrating an example of the flow of processing in accordance with a vehicle display control program relating to the embodiment.

### DETAILED DESCRIPTION

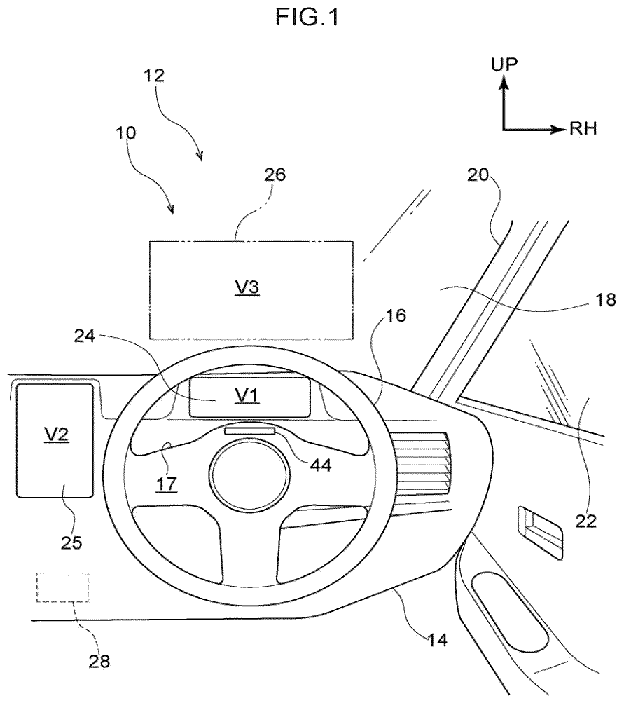

A vehicle display control system 10 equipped with a vehicle display control device 28 relating to an embodiment is described hereinafter with reference to the drawings. Note that arrow UP that is shown in FIG. 1 indicates the upper side in the vehicle vertical direction, and arrow RH indicates the right side in the vehicle transverse direction. The vertical direction and the left-right direction in the following explanation mean the vertical of the vehicle vertical direction and the left and right of the vehicle transverse direction, respectively.

FIG. 1 is a schematic drawing illustrating a portion of the vehicle cabin interior of a vehicle 12 that includes the vehicle display control device 28 relating to the present embodiment. The example of FIG. 1 illustrates a state in which the front portion of the vehicle cabin interior of the vehicle 12 is seen from the vehicle rear side.

As illustrated in FIG. 1, an instrument panel 14 is provided at the front portion of the vehicle cabin interior of the vehicle 12. The instrument panel 14 extends in the vehicle transverse direction, and a steering wheel 16 is provided at the vehicle right side of the instrument panel 14. Namely, in the present embodiment, the vehicle 12 is, as an example, a right-hand-drive vehicle in which the steering wheel 16 is provided at the right side, and the driver's seat is provided at the vehicle right side. Note that the present disclosure is not limited to this and may be applied to vehicles in which the driver's seat is set at the vehicle left side.

A windshield glass 18 is provided at the front end portion of the instrument panel 14. The windshield glass 18 extends in the vehicle vertical direction and the vehicle transverse direction, and separates the interior of the vehicle cabin and the exterior of the vehicle cabin.

A front pillar 20 at the vehicle right side is fixed to the vehicle right side end portion of the windshield glass 18. The front pillar 20 extends in the vehicle vertical direction, and the windshield glass 18 is fixed to the vehicle transverse direction inner side end portion of this front pillar 20. Further, the front end portion of a front side glass 22 is fixed to the vehicle transverse direction outer side end portion of the front pillar 20. Note that the vehicle left side end portion of the windshield glass 18 is fixed to a front pillar that is at the vehicle left side.

Here, a first display portion 24 that has a display region V1 for images is provided at the instrument panel 14. The first display portion 24 is structured at the vehicle right side of the instrument panel 14 by a meter display that is provided at the vehicle front side of the driver's seat. The first display portion 24 is connected to the various meter instruments installed in the vehicle 12, and is provided at a position that is within the field of view in the state in which the sightline of the passenger (hereinafter, also called “driver”) is directed toward the vehicle front side. The display region V1 is a region that the driver who is in the driver's seat can see through an opening portion 17 of the steering wheel 16.

A second display portion 25 that has a display region V2 for images is provided at the instrument panel 14. The second display portion 25 is structured by a center display disposed at the central portion in the vehicle transverse direction of the instrument panel 14.

A third display portion 26 that has a display region V3 for images is provided at the windshield glass 18. The third display portion 26 is set at the vehicle upper side of the first display portion 24 and is structured by a projected plane that is projected by a head-up display device serving as the display device. Specifically, the head-up display device that can project images is provided at the vehicle front side of the instrument panel 14, and images are projected from the head-up display device onto the third display portion 26 of the windshield glass 18. Namely, the third display portion 26 is a portion of the windshield glass 18 which portion is the projected plane of the head-up display device.

A sightline detecting sensor 44 is provided at the steering wheel 16. The sightline detecting sensor 44 is disposed so as to face the face of the driver seated in the driver's seat.

Here, the vehicle display control device 28 that structures the vehicle display control system 10 is provided at the vehicle 12. The vehicle display control device 28 of the present embodiment is, for example, an ECU (Electronic Control Unit) that carries out various types of control. The vehicle display control device 28 relating to the present embodiment is structured so as to display a first image, which shows the peripheral situation of the host (own) vehicle that supposes viewing from a virtual viewpoint, in at least one display region among the display region V1, the display region V2 and the display region V3 that are at the periphery of the driver's seat.

Hereinafter, as an example, description is given of a case in which an image (described later), which shows the peripheral situation and relates to the present embodiment, is displayed on the first display portion 24 of the vehicle 12. Note that the image showing the peripheral situation and relating to the present embodiment is not limited to being displayed on the first display portion 24, and may be displayed on the second display portion 25 or the third display portion 26.

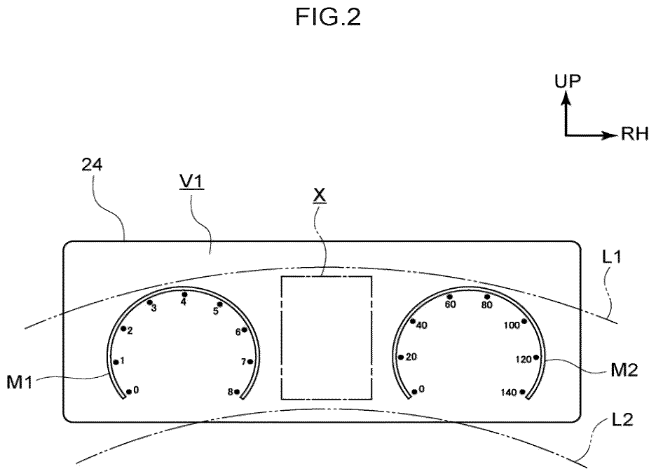

FIG. 2 is a drawing illustrating an example of the display region V1 of the first display portion 24 relating to the present embodiment.

As illustrated in FIG. 2, the vehicle display control device 28 displays images showing the peripheral situation of the vehicle 12, in region X that is a partial region of the display region V1. As described above, region X is a region that the driver in the driver's seat can see through the opening portion 17 of the steering wheel 16. Specifically, as illustrated in FIG. 2, the center of the region that the driver can see from between an upper edge ridgeline L1 and a lower edge ridgeline L2 of the opening portion 17 of the steering wheel 16 is region X. Meter displays M1, M2 showing meters of measuring instruments of the vehicle 12 are displayed at the left and the right of region X.

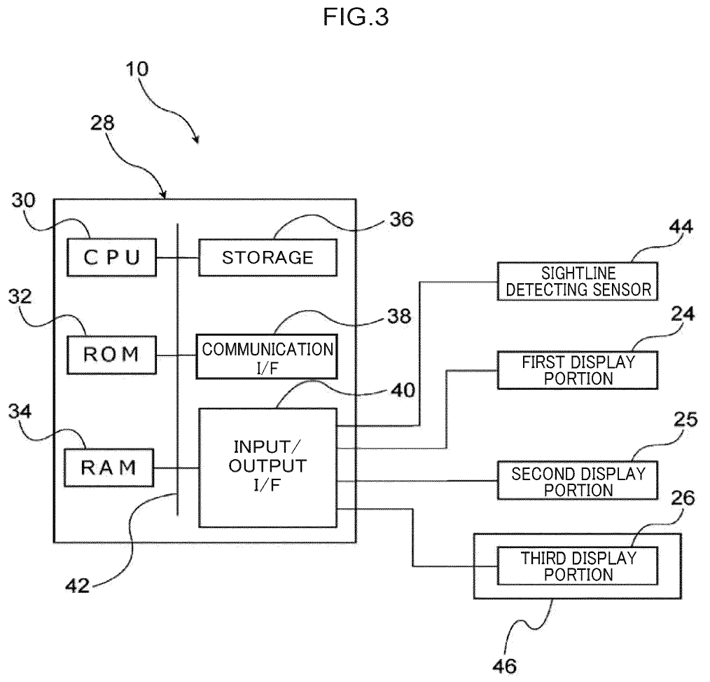

FIG. 3 is a block drawing illustrating an example of hardware structures of the vehicle display control device 28 relating to the present embodiment.

As illustrated in FIG. 3, the vehicle display control device 28 is structured to include a CPU (Central Processing Unit: processor) 30, a ROM (Read Only Memory) 32, a RAM (Random Access Memory) 34, a storage 36, a communication interface (communication I/F) 38, and an input/output interface (input/output I/F) 40. These respective structures are connected so as to be able to communicate with one another via internal bus 42.

The CPU 30 that is an example of a hardware processor executes various programs, controls respective sections, and functions as a peripheral information acquiring section, an attribute recognizing section and a display control section that are described later. Namely, the CPU 30 loads programs from the ROM 32 or the storage 36, and executes the programs by using the RAM 34 as a workspace. Further, the CPU 30 carries out control of the above-described respective structures, and various types of computing processings, in accordance with programs recorded in the ROM 32 or the storage 36.

The ROM 32 that is an example of the memory stores various programs and various data. The RAM 34 that is an example of the memory temporarily stores programs and data as a workspace. The storage 36 that is an example of the memory is structured by an HDD (Hard Disk Drive) or an SSD (Solid State Drive), and is a non-transitory storage medium that stores various programs, including the operating system, and various data. A vehicle display control program, for carrying out a vehicle display control processing relating to the present embodiment, is stored in the ROM 32 or the storage 36.

The communication interface 38 is an interface for the vehicle display control device 28 to communicate with servers and other devices, and standards such as, for example, CAN (Controller Area Network), Ethernet®, LTE (Long Term Evolution), FDDI (Fiber Distributed Data Interface), or Wi-Fi® are used thereat.

The sightline detecting sensor 44, the first display portion 24, the second display portion 25 and a head-up display device 46 are connected to the input/output interface 40. Further, images are projected by the head-up display device 46 onto the third display portion 26.

The sightline detecting sensor 44 is provided at the steering wheel 16, and is disposed so as to face the face of the driver seated in the driver's seat. By recognizing the eyes of a passenger, the sightline detecting sensor 44 detects the sightline direction of the passenger by using the principles of a corneal reflection method or a scleral reflection method or the like. Note that the sightline detecting sensor 44 may be provided at the instrument panel 14.

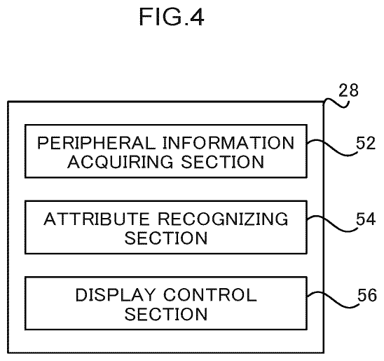

The vehicle display control device 28 realizes various functions by using the above-described hardware resources. The functional structures realized by the vehicle display control device 28 are described with reference to FIG. 4.

FIG. 4 is a block drawing illustrating an example of functional structures of the vehicle display control device 28 relating to the present embodiment.

As illustrated in FIG. 4, the vehicle display control device 28 is structured to include, as the functional structures thereof, a peripheral information acquiring section 52, an attribute recognizing section 54 and a display control section 56. Note that these respective functional structures are realized by the CPU 30 loading and executing the vehicle display control program stored in the ROM 32 or the storage 36.

The peripheral information acquiring section 52 acquires peripheral information expressing the situation at the periphery of the vehicle 12 (the host vehicle). Specifically, plural sensors that can detect the peripheral situation are provided at the vehicle 12, and information detected by these plural sensors is acquired as peripheral information.

Map information of the periphery of the vehicle 12 also is included in the peripheral information. A GPS receiver for acquiring the current position is provided at the vehicle 12. The peripheral information acquiring section 52 refers to the position information of the vehicle and to map data that is stored in an external server or the storage 36, and acquires map information of the periphery of the vehicle 12.

The attribute recognizing section 54 detects objects, which are positioned at the periphery of the host vehicle, from the peripheral information acquired by the peripheral information acquiring section 52, and recognizes the attributes of the detected objects. What is called “attribute” here includes plural types such as, for example, “sedan” expressing that the object is a passenger vehicle (including taxis), “bus” expressing that the object is a bus, “truck” expressing that the object is a truck, “motorcycle” expressing that the object is a motorcycle, “bicycle” expressing that the object is a bicycle, and “person” expressing that the object is a person. The attributes are not limited to these, and may be categorized more minutely. Note that a known method such as, for example, methods using pattern matching and methods using machine learning can be used as the method of recognizing attributes.

Each predetermined time period, the attribute recognizing section 54 can derive the probabilities of the attributes for a detected object. What is called “probability” here is an index value expressing the likelihood of an attribute. The higher the probability of an attribute, the higher the probability that the detected object has that attribute. Namely, each time a predetermined time period elapses, the attribute recognizing section 54 derives the probability of each attribute of a detected object, and confirms that the attribute, whose probability is greater than or equal to a threshold value, is the attribute of that object. When the attribute is confirmed, an identification number (ID) corresponding to that attribute is given. Even if an object whose attribute has been confirmed leaves the imaging ranges of the cameras, the ranges detected by the sensors are maintained as is. Note that appropriate values are set for the “predetermined time period” and the “threshold value” on the basis of prior knowledge or test results or the like. For example, a value of 90% or greater is set as the “threshold value”.

The display control section 56 displays an image, which shows the peripheral situation of the host vehicle, in a display region provided at the periphery of the driver's seat of the host vehicle. Here, the “image showing the peripheral situation of the host vehicle” is an image that supposes viewing from a virtual viewpoint. An image showing the attribute that has been confirmed by the attribute recognizing section 54 is included in the “image showing the peripheral situation of the host vehicle”. The “display region provided at a periphery of a driver's seat of the host vehicle” is, as described above, at least one display region among the display region V1, the display region V2 and the display region V3.

The virtual viewpoint is a viewpoint set in a virtual space. In the example of the present embodiment, the virtual viewpoint is set in a three-dimensional virtual space whose origin O is the position of the vehicle 12 (the host vehicle). This virtual viewpoint can be defined by the viewpoint coordinates and the viewpoint angle (orientation) in the virtual space.

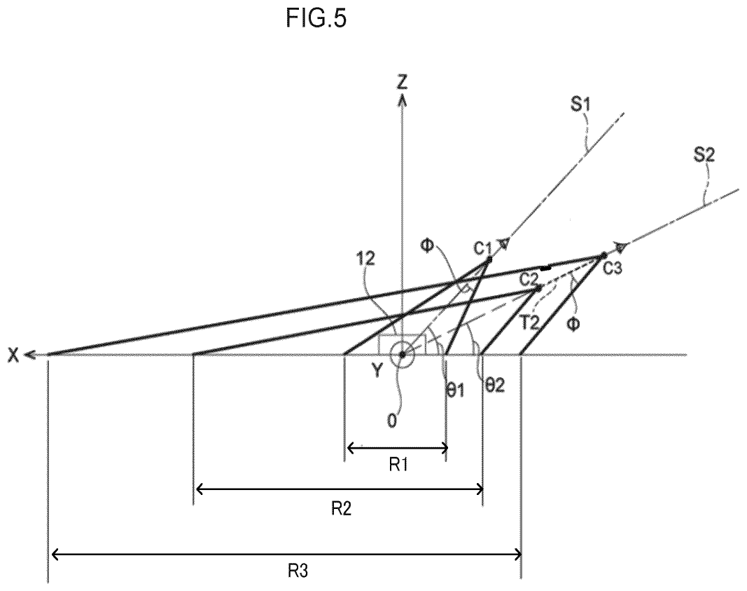

FIG. 5 is a drawing illustrating examples of a first virtual viewpoint C1 through a third virtual viewpoint C3 relating to the present embodiment.

As illustrated in FIG. 5, the virtual coordinates of virtual viewpoints C1 through C3 are three-dimensional coordinates with the vehicle longitudinal direction (advancing direction) of the vehicle 12 being the X-axis, the vehicle transverse direction being the Y-axis and the vehicle vertical direction being the Z-axis. The viewpoint angle can be expressed as a set of the rotation angles (roll, pitch, yaw angles) around these respective axes. Accordingly, the display control section 56 supposes viewing of the periphery of the vehicle 12 at a specific viewpoint angle from specific viewpoint coordinates in the virtual space, and generates an image showing the peripheral situation of the vehicle 12, and displays the image in a display region.

The first virtual viewpoint C1 is a viewpoint of viewing the vehicle 12 from a high position at an obliquely rear side. As an example, the viewpoint angle of the first virtual viewpoint C1 coincides with the direction of segment S1 that passes through the origin O and the viewpoint coordinates of the first virtual viewpoint C1, and has the largest rotation angle around the Y-axis (pitch angle) θ1. The display control section 56 generates an image of range R1 that can be seen at predetermined image angle ϕ from the first virtual viewpoint C1, and displays the image in a display region as an image showing the peripheral situation of the vehicle 12.

A second virtual viewpoint C2 is a viewpoint of viewing from further rearward than the first virtual viewpoint C1, and is a viewpoint of viewing from a position lower than the first virtual viewpoint C1. As an example, the viewpoint angle of the second virtual viewpoint C2 coincides with the direction of segment S2 that passes through the origin O and the viewpoint coordinates of the second virtual viewpoint C2, and the rotation angle around the Y-axis (the pitch angle) θ2 is smaller than the rotation angle θ1 of the first virtual viewpoint C1. Therefore, the second virtual viewpoint C2 is a viewpoint that is oriented more upwardly than the first virtual viewpoint C1. The display control section 56 generates an image of range R2 that can be seen at the predetermined image angle ϕ from the second virtual viewpoint C2, and displays the image in a display region as an image showing the peripheral situation of the vehicle 12.

The third virtual viewpoint C3 is a viewpoint of viewing from further rearward than the first virtual viewpoint C1 and the second virtual viewpoint C2, and is a viewpoint of viewing from a position that is lower than the first virtual viewpoint C1 and higher than the second virtual viewpoint C2. As an example, the viewpoint angle of the third virtual viewpoint C3 coincides with that of the second virtual viewpoint C2. The display control section 56 generates an image of range R3 that can be seen at the predetermined image angle ϕ from the third virtual viewpoint C3, and displays the image in a display region as an image showing the peripheral situation of the vehicle 12.

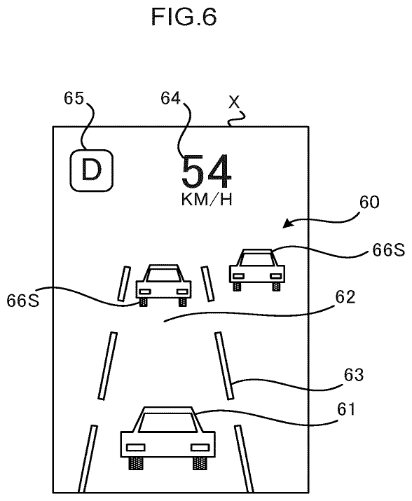

The display control section 56 relating to the present embodiment sets any virtual viewpoint among the first virtual viewpoint C1 through the third virtual viewpoint C3, and as illustrated in FIG. 6 for example, displays an image 60, which shows the peripheral situation of the vehicle 12, in region X that is a partial region of the display region V1.

FIG. 6 is a drawing illustrating an example of the image 60 that shows the peripheral situation of the vehicle 12 and is displayed in region X.

As illustrated in FIG. 6, as the image 60, the display control section 56 displays a lane image 62 showing the traveling lane of the vehicle 12 and a white line image 63 showing the white lines that demarcate the traveling lane, at the periphery of a host vehicle image 61 that shows the vehicle 12. Further, an image 64 showing the traveling speed of the vehicle 12 and an image 65 showing the shift position of the vehicle 12 are displayed above the lane image 62. An image (hereinafter called “sedan image”) 66S showing the attribute “sedan” is displayed above the host vehicle image 61.

Here, as described above, there are cases in which, among the objects at the periphery of the host vehicle that are displayed in region X, all of the objects of unclear attributes are displayed as “sedans”. An “object of an unclear attribute” means an object that, although it can be detected that the object is some type of object, what type of attribute that object has is unclear. For example, there are cases in which the attribute cannot be confirmed for reasons such as bad weather such as rain or snow, or the object being at a place that is far from the host vehicle. In such cases, the attribute is deemed to be unclear, and the sedan image 66S is displayed. Therefore, there is the concern that the driver will misunderstand the attribute of the object.

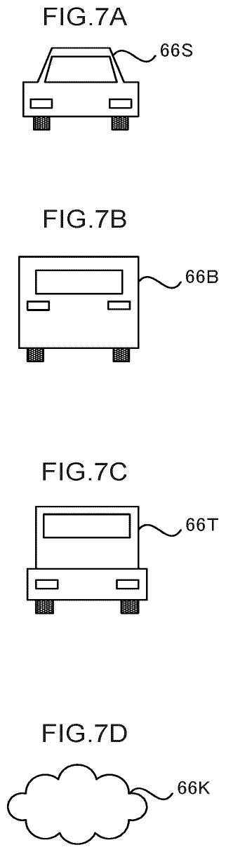

To address this, at the time of displaying images showing the peripheral situation of the host vehicle in region X, in a case in which the attribute of an object positioned at the periphery of the host vehicle is unclear, the display control section 56 relating to the present embodiment, up until the attribute is confirmed, displays the ambiguous object in a manner expressing that the attribute has not been confirmed. Namely, for objects whose attributes are unclear and that are positioned at the periphery of the host vehicle displayed in region X, the display control section 56, up until the attribute of the object is confirmed, carries out display in a manner expressing that the attribute of the object has not been confirmed. What is called “a manner expressing that the attribute of the object has not been confirmed” here is, as illustrated in FIG. 7D as an example, a specific image showing a predetermined shape. Due thereto, the driver misunderstanding the attribute of an object is suppressed.

FIG. 7A through FIG. 7D are drawings illustrating examples of images showing attributes of objects. FIG. 7A illustrates the sedan image 66S that is displayed in a case in which the attribute of the object is “sedan”. FIG. 7B illustrates an image (hereinafter called “bus image”) 66B that is displayed in a case in which the attribute of the object is “bus”. FIG. 7C illustrates an image (hereinafter called “truck image”) 66T that is displayed in a case in which the attribute of the object is “truck”. FIG. 7D illustrates a specific image 66K that is displayed in a case in which the attribute of the object is unclear.

Namely, for an object whose attribute has been confirmed, the sedan image 66S, the bus image 66B or the truck image 66T that shows the attribute is displayed, and, for an object whose attribute has not been confirmed, the specific image 66K that shows that the attribute has not been confirmed is displayed. Note that, in the example of FIG. 7D, a cloud-shaped image is displayed as an example of the specific image 66K, but the specific image is not limited to the shape of a cloud, and may be, for example, a circle, an oval, a triangle, a rectangle, or another shape. Further, a “?” mark for example may be added into the specific image 66K so as to explicitly show that the attribute has not been confirmed.

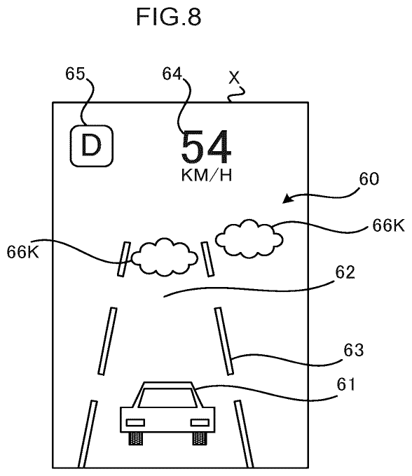

FIG. 8 is a drawing illustrating an example of the image 60 that includes the specific images 66K. For example, in a case in which the attributes of the objects corresponding to the sedan images 66S shown in above-described FIG. 6 are unclear, the specific images 66K are displayed instead of the sedan images 66S.

Further, the display control section 56 may change the displayed form of the specific image 66K in accordance with the probability of the attribute of the object. Various methods can be contemplated such as, for example, as the probability of the attribute increases, increasing the transparency of the specific image 66K, changing the color of the specific image 66K, changing the shape of the specific image 66K, or changing the size of the specific image 66K. Here, “transparency” is an index value expressing the degree to which the image can be seen through, and is a concept including transmittivity. The transparency may be the clarity. Due thereto, merely by glancing at the specific image 66K, the driver can understand the change in the probability of the attribute of the object.

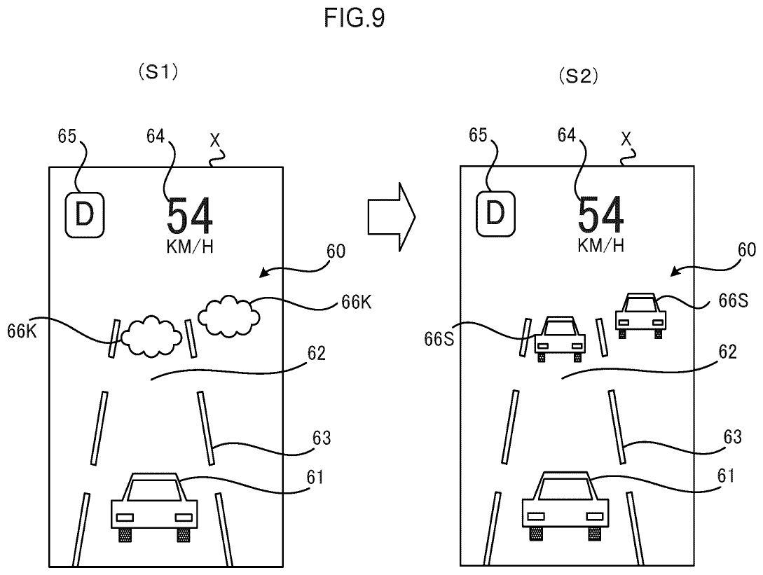

Further, in a case in which, among respective probabilities of plural types of attributes, any probability becomes greater than or equal to a threshold value, as illustrated as an example in FIG. 9, the display control section 56 may display, instead of the specific image 66K, an image showing the attribute whose probability has become greater than or equal to a threshold value.

FIG. 9 is a drawing illustrating a situation in which the specific images 66K displayed in region X transition to the sedan images 66S. In the example of FIG. 9, the attribute whose probability has become greater than or equal to a threshold value is “sedan”, and therefore, the sedan images 66S are displayed.

In (S1) of FIG. 9, the attribute recognizing section 54 detects objects positioned ahead of the vehicle 12, and derives the probabilities of the respective attributes for the detected objects. In a case in which the derived probability is less than a threshold value, the attribute of that object is judged to be unclear. The display control section 56 displays the specific image 66K because the attribute of the object is unclear.

In (S2), each predetermined time period, the attribute recognizing section 54 derives the probabilities of respective attributes of the detected objects. Instead of the specific image 66K, the display control section 56 displays an image (e.g., the sedan image 66S) showing the attribute whose derived probability has become greater than or equal to a threshold value. An image showing an attribute of high probability is thereby displayed, and therefore, misunderstanding of the attribute of the object is suppressed.

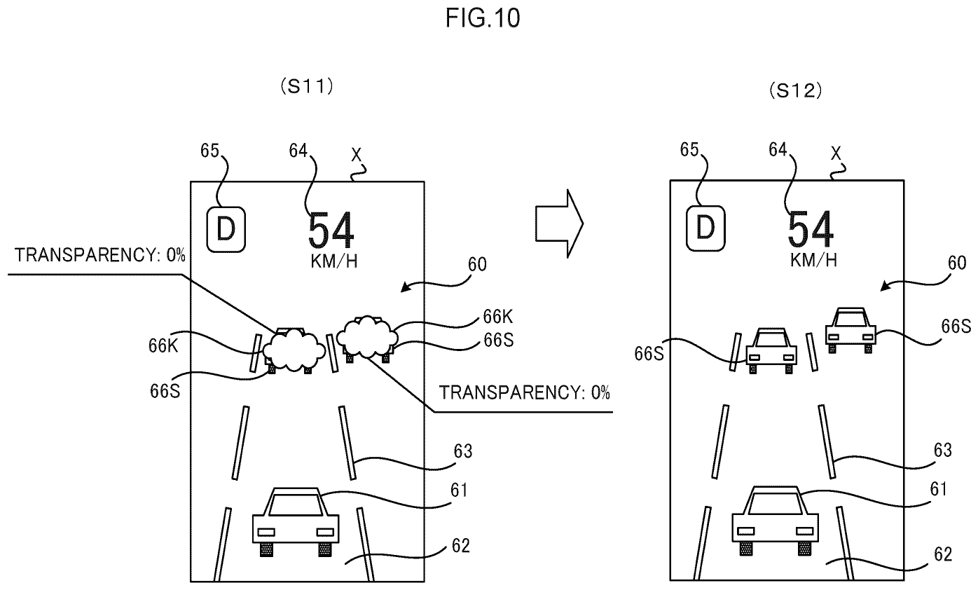

Further, as shown as an example in FIG. 10, the display control section 56 may display the specific image 66K so as to overlap an image showing the attribute that has the highest probability among respective probabilities of plural types of attributes, and when the attribute is confirmed, the display control section 56 may delete the specific image 66K. Note that it is judged that the attribute has been confirmed when the probability of that attribute becomes greater than or equal to a threshold value.

FIG. 10 is a drawing illustrating a situation in which the specific images 66K displayed in region X are deleted. In the example of FIG. 10, the sedan images 66S are displayed because the attributes of the highest probabilities are “sedan”.

In (S11) of FIG. 10, the attribute recognizing section 54 detects objects positioned ahead of the vehicle 12, and derives the probabilities of the respective attributes for the detected objects. In a case in which a derived probability is less than a threshold value, the attribute of that object is judged to be unclear. Further, the attribute recognizing section 54 specifies the attribute whose derived probability is the highest. The display control section 56 displays the specific image 66K so as to overlap the image (e.g., the sedan image 66S) showing the attribute of the highest probability. Note that, in the example of FIG. 10, because the transparencies of the specific images 66K are 0%, at least portions of the sedan images 66S are in states of being hidden by the specific images 66K.

In (S12), each predetermined time period, the attribute recognizing section 54 derives the probabilities of respective attributes of the detected objects. When the attribute of an object is confirmed, the display control section 56 deletes the specific image 66K. In the example of FIG. 10, because it is confirmed that the attributes of the objects are “sedan”, the specific images 66K are deleted, and the sedan images 66S are displayed. Images showing attributes of high probabilities are thereby displayed, and therefore, misunderstanding of the attributes of the objects is suppressed.

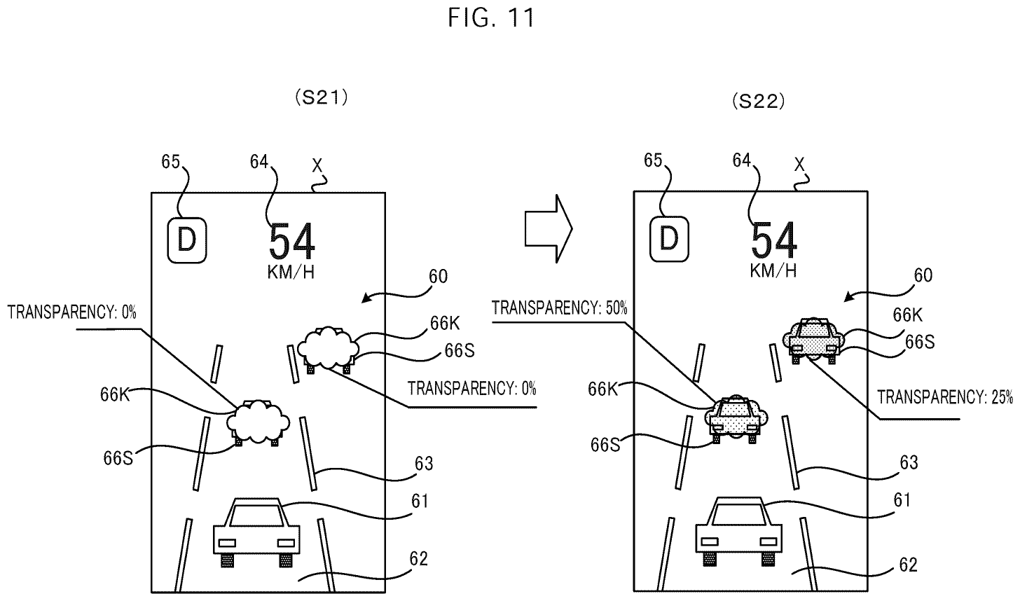

Further, as shown as an example in FIG. 11, the display control section 56 may display the specific image 66K so as to overlap an image showing the attribute that has the highest probability among the respective probabilities of plural types of attributes, and may increase the transparency of the specific image 66K as the probability of the attribute increases. Note that the changing of the transparency may be in stages or may be continuous.

FIG. 11 is a drawing illustrating a situation in which the transparencies of the specific images 66K displayed in region X are changed. In the example of FIG. 11, the sedan images 66S are displayed because the attributes of the highest probabilities are “sedan”.

In (S21) of FIG. 11, the attribute recognizing section 54 detects objects positioned ahead of the vehicle 12, and derives the probabilities of the respective attributes for the detected objects. In a case in which a derived probability is less than a threshold value, the attribute of that object is judged to be unclear. Further, the attribute recognizing section 54 specifies the attribute whose derived probability is the highest. The display control section 56 displays the specific image 66K so as to overlap the image (e.g., the sedan image 66S) showing the attribute of the highest probability. In the example of FIG. 11, because the transparencies of the specific images 66K are 0%, at least portions of the sedan images 66S are in states of being hidden by the specific images 66K.

In (S22), each predetermined time period, the attribute recognizing section 54 derives the probabilities of respective attributes for the detected objects. The display control section 56 increases the transparency of the specific image 66K as the probability of the attribute increases. In the example of FIG. 11, because the probabilities of the attributes (“sedan” here) of the objects are high, the transparencies of the specific images 66K are high, and the sedan images 66S are displayed so as to be able to be seen through the specific images 66K. When the transparency of the specific image 66K gradually becomes higher, the sedan image 66S is gradually displayed more distinctly, and is displayed in a state in which the so-called “mist” thereon clears off. Note that, when the probability becomes greater than or equal to a threshold value, the attribute is confirmed, and there becomes a state in which the transparency of the specific image 66K is 100%, i.e., the specific image 66K is deleted. Due thereto, the probability of the attribute of an object can be understood from the change in the transparency of the specific image 66K.

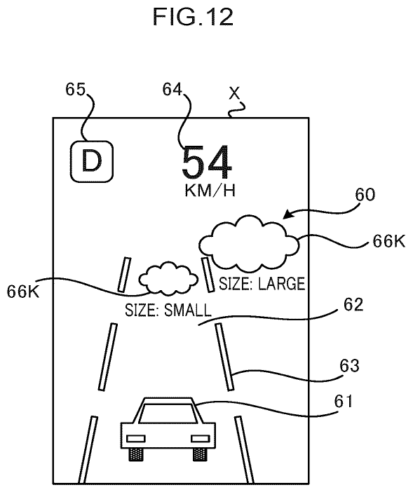

Further, as illustrated in FIG. 12 as an example, the display control section 56 may vary the size of the specific image 66K in accordance with the size of the object. Note that the size of the object is acquired by the attribute recognizing section 54.

FIG. 12 is a drawing illustrating a state in which the sizes of the specific images 66K displayed in region X are varied.

For example, in a case in which the attributes of the objects, which are positioned in front of and at an obliquely front and right side of the vehicle 12, are unclear, and the size of the object in front is relatively small, and the size of the object that is obliquely forward and right is relatively large, as illustrated in FIG. 12, the size of the specific image 66K corresponding to the object in front is made small, and the size of the specific image 66K corresponding to the object at the obliquely front, right side is made large. Due thereto, a sense of the sizes of the objects can be understood merely by glancing at the specific images 66K.

Further, plural specific images 66K, at which at least one of the size and the transparency thereof is different, are stored in advance in the storage 36. The storage 36 is an example of the storing section. The display control section 56 selectively displays any of the plural specific images 66K stored in the storage 36, up until the attribute of the object is confirmed.

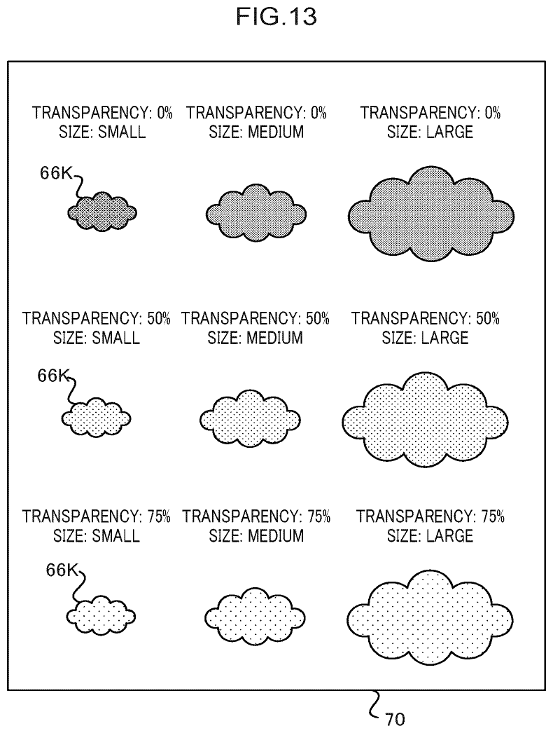

FIG. 13 is a drawing showing an example of a specific image database 70. The specific image database (DB) 70 is stored in the storage 36 for example.

The plural specific images 66K, at which at least one of the size and the transparency thereof is different, are registered in the specific image DB 70 illustrated in FIG. 13. Various types of specific images 66K can thereby be displayed.

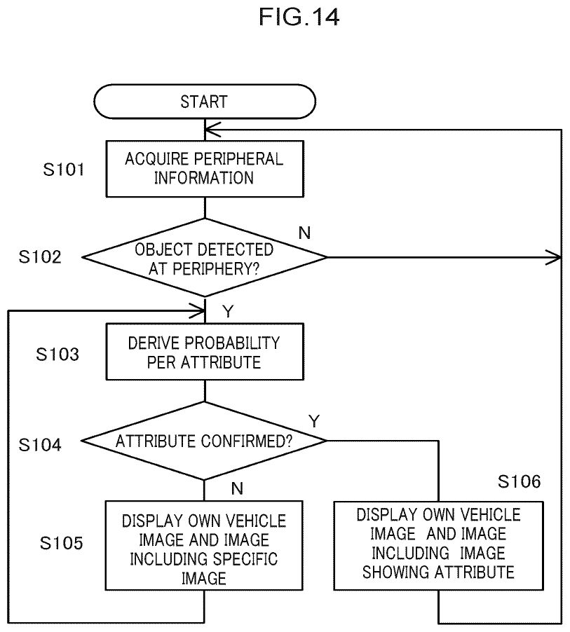

Operation of the vehicle display control device 28 relating to the present embodiment is described next with reference to FIG. 14.

FIG. 14 is a flowchart illustrating an example of the flow of processing in accordance with the vehicle display control program relating to the present embodiment.

First, when the vehicle display control device 28 is instructed to execute the vehicle display control processing, the vehicle display control program is started-up by the CPU 30, and the following steps are executed.

In step S101 of FIG. 14, the CPU 30 acquires peripheral information expressing the peripheral situation of the vehicle 12. Specifically, as described above, plural sensors that can detect the peripheral situation are provided at the vehicle 12, and the information detected by these plural sensors is acquired as the peripheral information.

In step S102, the CPU 30 judges whether or not an object has been detected in the periphery of the vehicle 12, from the peripheral information acquired in step S101. If the CPU 30 judges that an object has been detected (an affirmative judgement), the CPU 30 moves on to step S103. If the CPU 30 judges that an object has not been detected (a negative judgment), the CPU 30 returns to step S101 and repeats processing.

In step S103, for a detected object, the CPU 30 derives the probability per attribute such as, for example, “sedan”, “bus”, “truck”.

In step S104, the CPU 30 judges whether or not, among the probabilities of the respective attributes that were derived in step S103, any of the probabilities has become greater than or equal to a threshold value, i.e., whether or not an attribute has been confirmed. If it is judged that no attribute has been confirmed (a negative judgment), the CPU 30 moves on to step S105. If it is judged that an attribute has been confirmed (an affirmative judgement), the CPU 30 moves on to step S106.

In step S105, as shown in (S1) of above-described FIG. 9 as an example, the CPU 30 displays the image 60, which includes the host vehicle image 61 and the specific images 66K, in region X, and returns to step S103 and repeats processing.

On the other hand, in step S106, as shown in (S2) of above-described FIG. 9 as an example, the CPU 30 displays the image 60, which includes the host vehicle image 61 and images showing the attributes (e.g., the sedan images 66S), in region X, and returns to step S101 and repeats processing.

In this way, in accordance with the present embodiment, attributes of ambiguous objects that are positioned at the periphery of the host vehicle can be displayed in manners such that the passenger does not misunderstand the attributes. Therefore, a passenger misunderstanding attributes of objects is suppressed. Because a passenger misunderstanding attributes of objects is suppressed, mistakes in driving operations by the passenger can be reduced, and the driving operation experience for the passenger can be improved.

Note that the vehicle display control processing, which is executed by the CPU 30 reading-in software (a program) in the above-described embodiment, may be executed by any of various types of processors other than a CPU. Examples of processors in this case include PLDs (Programmable Logic Devices) whose circuit structure can be changed after production such as FPGAs (Field-Programmable Gate Arrays), and dedicated electrical circuits that are processors having circuit structures that are designed for the sole purpose of executing specific processings such as ASICs (Application Specific Integrated Circuits). Further, the vehicle display control processing may be executed by one of these various types of processors, or may be executed by a combination of two or more of the same type or different types of processors (e.g., plural FPGAs, or a combination of a CPU and an FPGA). Further, the hardware structures of these various types of processors are, more specifically, electrical circuits that combine circuit elements such as semiconductor elements.

Further, the above embodiment describes a form in which the vehicle display control program is stored in advance (is installed) in the ROM 32 or the storage 36, but the present disclosure is not limited to this. The vehicle display control program may be provided in a form of being stored on a recording medium such as a CD-ROM (Compact Disk Read Only Memory), a DVD-ROM (Digital Versatile Disk Read Only Memory), or a USB (Universal Serial Bus) memory. Further, the vehicle display control program may be in a form of being downloaded over a network from an external device. The vehicle display control program may be a program product.

In addition, the structure of the vehicle display control device described in the above embodiment is an example, and may be changed in accordance with the situation and within a scope that does not depart from the gist thereof.

Further, the flow of the processing of the program described in the above embodiment also is an example, and unnecessary steps may be deleted therefrom, new steps may be added thereto, or the order of processings may be rearranged within a scope that does not depart from the gist thereof.

An object of the present disclosure is to provide a vehicle display control device and a vehicle display control method that can display an attribute of an ambiguous object positioned at the periphery of a host vehicle in a manner such that a passenger will not misunderstand the attribute.

A first aspect of the present disclosure is a vehicle display control device, including: a memory; and a processor coupled with the memory, the processor being configured to: acquire a peripheral situation of a host vehicle via a sensor; and at a time of displaying an image showing the peripheral situation of the host vehicle at a display provided at a periphery of a driver's seat of the host vehicle, in a case in which an attribute of an object positioned at a periphery of the host vehicle is unclear, display the object in a manner expressing that the attribute has not been confirmed, up until the attribute is confirmed.

In the vehicle display control device relating to the first aspect, the attribute of an ambiguous object positioned at the periphery of a host vehicle can be displayed in a manner such that a passenger will not misunderstand the attribute. Therefore, the passenger misunderstanding the attribute of an object is suppressed.

A second aspect of the present disclosure is the vehicle display control device of the first aspect, wherein: the manner is a specific image showing a predetermined shape, and the processor is configured to change a displayed form of the specific image in accordance with a probability expressing a likelihood of an attribute of the object.

In the vehicle display control device relating to the second aspect, a change in the probability of the attribute of the object can be understood merely by glancing at the specific image.

A third aspect of the present disclosure is the vehicle display control device of the second aspect, wherein: the attribute is a plurality of types of attributes, and the processor is configured to, in a case in which any probability, among respective probabilities of the plurality of types of attributes, becomes greater than or equal to a threshold value, display, instead of the specific image, an image showing the attribute having a probability that has become greater than or equal to the threshold value.

In the vehicle display control device relating to the third aspect, an image showing the attribute that has the highest probability is displayed instead of the specific image. Therefore, the passenger misunderstanding the attribute of the object is suppressed.

A fourth aspect of the present disclosure is the vehicle display control device of the second aspect, wherein: the attribute is a plurality of types of attributes, and the processor is configured to display the specific image so as to overlap with an image showing an attribute that has a highest probability among respective probabilities of the plurality of types of attributes, and, in a case in which the attribute is confirmed, delete the specific image.

In the vehicle display control device relating to the fourth aspect, the specific image is deleted, and an image showing the attribute that has the highest probability is displayed. Therefore, the passenger misunderstanding the attribute of the object is suppressed.

A fifth aspect of the present disclosure is the vehicle display control device of the second aspect, wherein: the attribute is a plurality of types of attributes, and the processor is configured to display the specific image so as to overlap with an image showing an attribute that has a highest probability among respective probabilities of the plurality of types of attributes, and, as the probability of the attribute increases, increase transparency of the specific image.

In the vehicle display control device relating to the fifth aspect, the probability of the attribute of the object can be understood due to the change in the transparency of the specific image.

A sixth aspect of the present disclosure is the vehicle display control device of the first aspect, wherein: the manner is a specific image showing a predetermined shape, and the processor is configured to vary a size of the specific image in accordance with a size of the object.

In the vehicle display control device relating to the sixth aspect, a sense of the size of the object can be grasped merely by glancing at the specific image.

A seventh aspect of the present disclosure is the vehicle display control device of the first aspect, wherein: the manner is a specific image showing a predetermined shape, a plurality of specific images, at which at least one of a size and transparency is different, are stored in the memory in advance, and up until an attribute of the object is confirmed, the processor is configured to selectively display any of the plurality of specific images that are stored in the memory.

In the vehicle display control device relating to the seventh aspect, various types of specific images can be displayed.

A eighth aspect of the present disclosure is a vehicle display control method, the method including: by a processor, acquiring a peripheral situation of a host vehicle; and at a time of displaying an image showing the peripheral situation of the host vehicle at a display provided at a periphery of a driver's seat of the host vehicle, in a case in which an attribute of an object positioned at a periphery of the host vehicle is unclear, displaying the object in a manner expressing that the attribute has not been confirmed, up until the attribute is confirmed.

A ninth aspect of the present disclosure is a non-transitory computer-readable recording medium storing a program that causes a computer to execute a vehicle display control process, the process including: acquiring a peripheral situation of a host vehicle; and at a time of displaying an image showing the peripheral situation of the host vehicle at a display provided at a periphery of a driver's seat of the host vehicle, in a case in which an attribute of an object positioned at a periphery of the host vehicle is unclear, displaying the object in a manner expressing that the attribute has not been confirmed, up until the attribute is confirmed.

As described above, in accordance with the present disclosure, an attribute of ambiguous object positioned at the periphery of a host vehicle can be displayed in a manner that is such that a passenger will not misunderstand the attribute.

What is claimed is:

1. A vehicle display control device, comprising:
a memory; and
a processor coupled with the memory, the processor being configured to:
acquire a peripheral situation of a host vehicle via a sensor; and
at a time of displaying an image showing the peripheral situation of the host vehicle at a display provided at a periphery of a driver's seat of the host vehicle, in a case in which an attribute of an object positioned at a periphery of the host vehicle is unclear, display the object in a manner expressing that the attribute has not been confirmed, up until the attribute is confirmed.

2. The vehicle display control device of claim 1, wherein:
the manner is a specific image showing a predetermined shape, and
the processor is configured to change a displayed form of the specific image in accordance with a probability expressing a likelihood of an attribute of the object.

3. The vehicle display control device of claim 2, wherein:
the attribute is a plurality of types of attributes, and
the processor is configured to, in a case in which any probability, among respective probabilities of the plurality of types of attributes, becomes greater than or equal to a threshold value, display, instead of the specific image, an image showing the attribute having a probability that has become greater than or equal to the threshold value.

4. The vehicle display control device of claim 2, wherein:
the attribute is a plurality of types of attributes, and
the processor is configured to display the specific image so as to overlap with an image showing an attribute that has a highest probability among respective probabilities of the plurality of types of attributes, and, in a case in which the attribute is confirmed, delete the specific image.

5. The vehicle display control device of claim 2, wherein:
the attribute is a plurality of types of attributes, and
the processor is configured to display the specific image so as to overlap with an image showing an attribute that has a highest probability among respective probabilities of the plurality of types of attributes, and, as the probability of the attribute increases, increase transparency of the specific image.

6. The vehicle display control device of claim 1, wherein:
the manner is a specific image showing a predetermined shape, and
the processor is configured to vary a size of the specific image in accordance with a size of the object.

7. The vehicle display control device of claim 1, wherein:
the manner is a specific image showing a predetermined shape,
a plurality of specific images, at which at least one of a size and transparency is different, are stored in the memory in advance, and
up until an attribute of the object is confirmed, the processor is configured to selectively display any of the plurality of specific images that are stored in the memory.

8. A vehicle display control method, the method comprising:
by a processor,
acquiring a peripheral situation of a host vehicle; and
at a time of displaying an image showing the peripheral situation of the host vehicle at a display provided at a periphery of a driver's seat of the host vehicle, in a case in which an attribute of an object positioned at a periphery of the host vehicle is unclear, displaying the object in a manner expressing that the attribute has not been confirmed, up until the attribute is confirmed.

9. A non-transitory computer-readable recording medium storing a program that causes a computer to execute a vehicle display control process, the process comprising:
acquiring a peripheral situation of a host vehicle; and
at a time of displaying an image showing the peripheral situation of the host vehicle at a display provided at a periphery of a driver's seat of the host vehicle, in a case in which an attribute of an object positioned at a periphery of the host vehicle is unclear, displaying the object in a manner expressing that the attribute has not been confirmed, up until the attribute is confirmed.
